(19) United States
(12) Patent Application Publication
(10) Pub. No.: US 2009/0042520 A1
(43) Pub. Date: Feb. 12, 2009

(54) Envelope tracking RF amplifier

(75) Inventor: Geoffrey Norman Mendenhall, Cincinnati, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Harris Corporation

(21) Appl. No.: 12/217,262

(22) Filed: Jul. 1, 2008

Related U.S. Application Data
(63) Continuation-in-part of application No. 11/890,573, filed on Aug. 7, 2007.

(51) Int. Cl. H04B 1/02

(52) U.S. Cl. 455/108

(57) ABSTRACT

Apparatus is presented for broadcasting an RF signal. This includes an amplifier having a first input and a second input for a vacuum tube amplifier embodiment. A sampler receives a composite RF signal and provides therefrom a sample signal and a driver signal each signal having digital and analog components. An envelope extractor receives the sample signal and provides therefrom an amplitude modulated baseband signal for application to the second input bias power supply on a vacuum tube or the first input bias supply on an MOS-FET device. The RF sampler circuit supplies the drive signal including both amplitude and phase modulation to the first input (grid or gate) of the RF amplifier.

### RELATED APPLICATION

This is a continuation-in-part of U.S. application Ser. No. 11/890,573, filed Aug. 7, 2007.

### BACKGROUND OF THE INVENTION

1. Technical Field

The present invention is directed to broadcast transmission and communication systems in general, and is particularly related to improving the efficiency of radio frequency power amplifiers. The present invention relates to broadcasting RF signals and, more particularly, to improvements permitting both analog and digital components to be transmitted employing a common amplifier. Applications would include FM+HD Radio transmitters for the amplification of DAB, IBOC, (HD Radio) signals.

2. Description of the Prior Art

The introduction of HD Radio broadcasting at higher power levels has increased demand for high power VHF transmitters capable of simultaneous, common, amplification of digital, HD Radio signals with the analog FM signal. Improving the efficiency of the high power RF amplifier is important for reducing power consumption and the cooling requirements of the transmitter providing both economic and environmental benefits.

The introduction of digital audio broadcasting (DAB) and other forms of vector modulation require simultaneous amplitude and phase modulation of the RF carrier. Conventional FM broadcast transmitters utilize nonlinear RF power amplifiers that cannot convey the amplitude variations needed to accurately replicate the vector modulation.

In the prior art, it is known to employ separate amplification of the vector modulation signal and of the analog FM signal. An example of this is disclosed in FIG. 1 herein. In this example, the output V₂ of an existing FM transmitter 10, illustrated as a main FM transmitter, is combined with the output V₃ from a digital transmitter referred to as a digital TX (linear) transmitter. The input to the main transmitter 10 is obtained from a conventional FM signal source 14 while the input to the digital transmitter 12 is obtained from a conventional IBOC source 16. The outputs V₂ and V₃ of these transmitters are combined in a conventional coupler C, which typically is a 10 dB coupler. The coupler, which is sometimes known as an output coupler, provides an output V₁ that is supplied to a transmitting antenna 20 for broadcasting the composite signal. The coupler C has ports 1, 2, 3 and 4 with the voltages V₂ and V₃ being applied to ports 2 and 3. The output at port 1 is supplied to the antenna 20. Port 4 is coupled to a reject load RL.

Because the outputs V₁ and V₂ are combined only after they have reached a high level of amplitude (because they have already been amplified by separate amplifiers) this is referred to in the art as “high-level combining” or “separate amplification”. This type of combining results in high losses because the two signals are not correlated. This may be viewed as the penalty paid for the simplicity involved. In a 10 dB coupler, some of the problems noted include the following: the main FM transmitter needs to have enough headroom in order to increase its output power to overcome the combiner insertion loss. This can be very problematic in specific installations without additional headroom to spare. Major hardware upgrade could be necessary to overcome this issue, such as by replacing the existing main FM transmitter with a more powerful transmitter. A second problem with this type of system is that the overall dissipation increases. Besides the power dissipated by digital transmitter 12, additional energy is wasted at this reject load RL where up to 10% of the main transmitter FM output and up to 90% of the output of the digital transmitter will be dissipated. This inefficiency creates additional heat load for the air-conditioning equipment.

Other prior art examples include the U.S. patents to Murphy et al. U.S. Pat. No. 5,315,583 and Papadopoulos et al. U.S. Pat. No. 6,144,705. It will be noted that the example in FIG. 1 requires a separate linear power amplifier to add the vector modulator signal to the existing analog FM signal. This technique, therefore, requires a second transmitter and inefficient RF combining of the two RF signals. Alternatively, the combined analog and digital signals provided in the composite signal, can be amplified together in a single, linear RF amplifier, with low efficiency. This technique is known as linear, common amplification.

It is desired to add the vector modulation amplitude and phase components to the same quasi-linear amplifier used to simultaneously amplify the constant amplitude, analog FM signal and the non-constant digital HD radio signal. This is the subject of the invention herein to be described below. This invention will allow the existing FM broadcast transmitter to add vector modulation to the existing FM signal without the need for a second transmitter and inefficient RF combining equipment.

### SUMMARY OF THE INVENTION

In accordance with the present invention, an apparatus is provided for broadcasting an RF signal. This apparatus includes a signal amplifier having a first input and a second input. A sampler receives a composite RF signal and provides therefrom a sample signal and a driver signal with each signal having digital and analog components. An envelope extractor receives the sample signal and provides therefrom an amplitude modulated baseband signal for application to the second input of the amplifier. Circuitry also supplies the drive signal to the second input of the amplifier.

In accordance with the more limited aspect of the present invention, the second input is a screen grid and the first input is a control grid wherein the amplifier includes a vacuum tube or the gate terminal wherein the amplifier includes a MOS-FET device.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 illustrates a block diagram illustration of a prior art combining circuit;

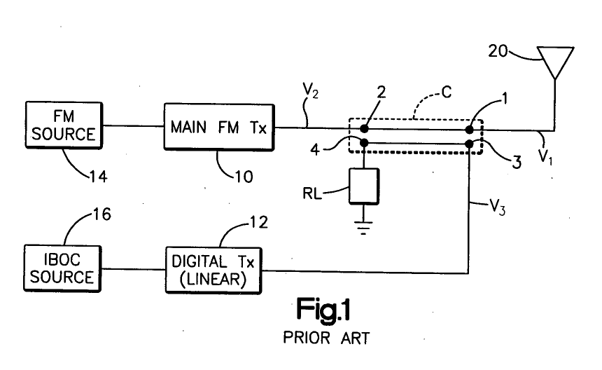

FIG. 2 is a schematic-block diagram illustration of one embodiment of the present invention in a vacuum tube RF power amplifier; and

FIG. 3 is a schematic-block diagram illustration of another embodiment of the present invention in a MOS-FET RF power amplifier.

### DESCRIPTION OF PREFERRED EMBODIMENTS

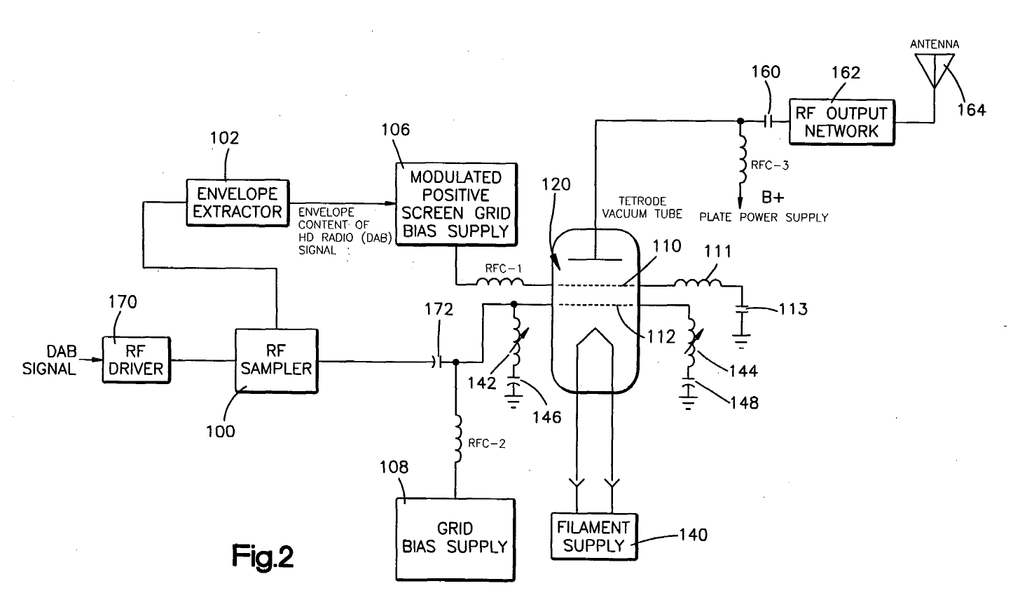

Existing high power FM broadcast transmitters normally employ a vacuum tube in the final RF power amplifier that is operated in a saturated Class-C mode. It is not possible to add the second vector modulated signal to the input of this nonlinear amplifier without first partially linearizing the amplifier to reproduce the crest factor of the combined FM+vector modulated signal. There is a unique combination of screen voltage and output circuit loading for each power output operating level. The average power output of the combined FM+HD Radio signal is several dB lower than the peak power output required to pass the peaks of the HD Radio component. If the combination of screen voltage and output loading is optimized to pass these peaks, the amplifier will operate with lower efficiency when these peaks are not present. This invention changes the ratio of screen voltage to output loading as required to follow the amplitude requirements of the HD Radio signal component and maintain the optimum ratio. It is proposed that the amplitude information representing the envelope variations of the vector modulated signal be applied to the screen grid of the vacuum tube amplifier or the gate terminal of a MOS-FET device. This is achieved by superimposing a wide bandwidth, analog, baseband, voltage representing the instantaneous amplitude of the vector modulation on top of the DC bias normally applied to the screen grid of the vacuum tube (see FIG. 2).

Screen Grid Power Supply AC Impedance: The method of injecting the analog baseband signal representing the amplitude modulation must maintain a low AC impedance for the screen grid DC bias supply 106 and from the screen grid to ground. A wide bandwidth (>1 MHz) analog operational power amplifier in supply 106 is inserted in series with the ground return of the screen grid bias supply. The instantaneous analog voltage adds to and subtracts from the DC screen grid voltage, thereby changing the operating point of the amplifier tube in proportion to the amplitude of the vector modulated signal.

Pre-correction for non-linearities: Varying the voltage on the screen grid of the power amplifier does not. change the operating point exactly proportional to this voltage variation. Pre-correction of the modulating signal is required to compensate for this system nonlinearity.

The composite drive signal which contains both the envelope and phase components of the combined digital and analog signals is applied to the control grid of the power amplifier.

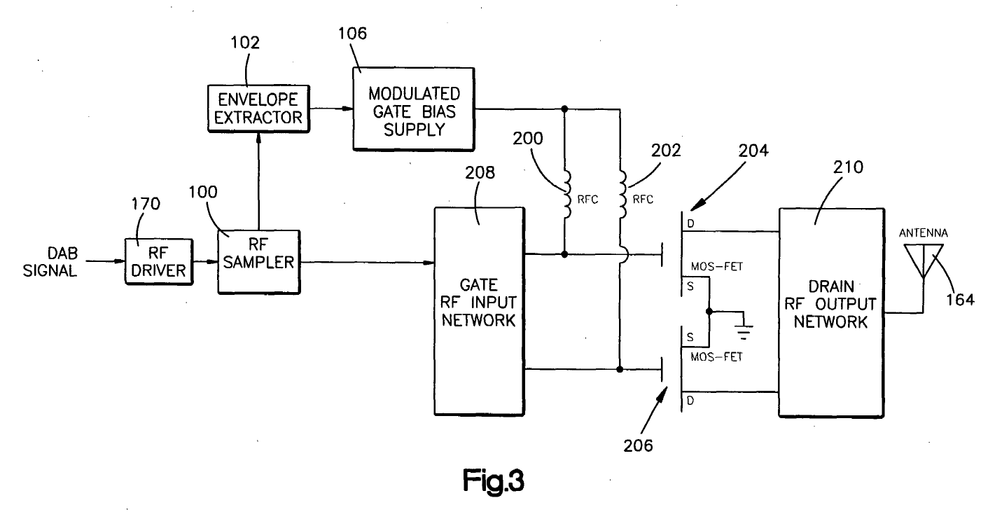

Reference is now made to FIG. 2 and FIG. 3. The circuit of FIG. 2 presents the embodiment of circuitry to achieve the foregoing objectives. Here a combined analog FM+digital HD Radio signal is supplied to a linear RF driver stage 170. The driver stage's RF output waveform is sampled by the RF sampler 100 as it passes on to the grid input DC blocking capacitor 172. The RF sample of the driver signal is supplied to an envelope extractor 102. The envelope component extractor (for example, a precision envelope detector) supplies a baseband signal including the amplitude information representing the envelope variations of the vector modulated signal to a modulated positive screen grid bias supply 106. The output of the positive screen grid bias supply 106 is supplied by way of an RF isolation inductor (choke) RFC-1 to the screen grid 110. In this manner, a wide band analog baseband voltage signal that represents the instantaneous amplitude of the vector modulation is superimposed on top of the DC bias normally applied to the screen grid of the tube 120. The tube 120 is also connected at its plate to a plate power supply B+ by way of a third inductor RFC-3. Additionally, a filament supply 140 is connected to the filament of the tetrode. The control grid 112 is connected by way of adjustable inductors 142 and 144 and capacitors 146 and 148 to ground. The output from the tetrode tube is applied by way of a DC blocking capacitor 160 and a typical RF output network 162 to a broadcasting antenna 164. Both the amplitude and phase information from the composite FM+HD Radio signal is supplied by way of an RF driver 170 and capacitor 172 to the control grid 112 of tube 120.

FIG. 3 illustrates a similar embodiment of this invention to a MOS-FET RF power amplifier.

Although the invention has been described in conjunction with preferred embodiments, it is to be appreciated that various modifications may be made without departing from the spirit and scope of the invention as defined by the appended claims.

Having described the invention, I claim:

1. Apparatus for broadcasting an RF signal comprising:
an amplifier having a first input and a second input;
a sampler that receives a composite RF signal and provides therefrom a sample signal and a driver signal each signal having digital and analog components;
an envelope extractor that receives said sample signal and provides therefrom an amplitude modulated baseband signal for application to said second input; and
circuit means that supplies said drive signal to said first input.

2. Apparatus as set forth in claim 1, wherein said amplifier includes a tube and wherein said second input is a screen grid and said first input is a control grid.

3. Apparatus as set forth in claim 1 wherein said digital component includes a vector modulated signal.

4. Apparatus as set forth in claim 3 wherein said envelope extractor supplies an amplitude modulated baseband signal as a wide bandwidth signal to said amplifier gain control element.

5. Apparatus as set forth in claim 1 wherein amplitude information representing the envelope variations is supplied to said amplifier.

6. Apparatus as set forth in claim 5 wherein said amplifier includes a control input.

7. Apparatus as set forth in claim 6 wherein said amplitude information is provided by superimposing a wide bandwidth signal representing the amplitude of said vector modulation to said amplifier.

8. Apparatus as set forth in claim 7 wherein said amplifier includes a vacuum tube and wherein said control input includes the control grid of said tube or gate terminal of a MOS-FET device.

9. Apparatus as set forth in claim 8 wherein said tube control grid or MOS-FET gate is coupled to said sampler by a capacitor.

10. Apparatus as set forth in claim 9, including an RF driver for supplying said composite FM+HD Radio signal to said sampler.

11. Apparatus as set forth in claim 1, including a modulated positive screen grid bias supply interposed between said envelope extractor and said second input.

12. Apparatus as set forth in claim 1, including a modulated gate bias supply interposed between said envelope extractor and said first input (gate terminal).
